(19) United States
(12) Patent Application Publication
(10) Pub. No.: US 2012/0212085 A1
(43) Pub. Date: Aug. 23, 2012

(54) AXIAL-FLUX ELECTRIC MACHINE

(75) Inventors: Weinong Fu, Hong Kong (HK); Siu-lau Ho, Hong Kong (HK)

(73) Assignee: THE HONG KONG POLYTECHNIC UNIVERSITY, Kowloon (HK)

(21) Appl. No.: 13/030,113

(22) Filed: Feb. 17, 2011

(51) Int. Cl. H02K 9/02; H02K 16/02

(52) U.S. Cl. 310/58; 310/114

(57) ABSTRACT

An axial-flux electric motor includes a stator having a plurality of stator windings and a plurality of stator pole-pairs, a first rotor configured to magnetically interact with the stator in an axial direction, the first rotor is positioned on one side of the stator, having a plurality of permanent magnets embedded thereon with a plurality of rotor pole-pairs, a second rotor configured to magnetically interact with the stator in the axial direction, the second rotor is position on another side of the stator, having a plurality of permanent magnets embedded thereon with a plurality of rotor pole-pairs, and a plurality of stationary ferromagnetic segments, positioned between the stator and the first rotor and between the stator and the second rotor, the ferromagnetic segments are adapted to modulate magnetic field of the permanent magnets in the axial direction.

### BACKGROUND OF THE INVENTION

1. Field of the Invention

The present invention relates to magnetic flux-modulation machines, more particularly, to axial-flux modulated motors.

2. Description of the Related Art

Emissions from gasoline driven automobiles are one of the main causes of environmental pollution. One of the solutions to reducing air pollution is to replace motor vehicles with gasoline combustion engine with low-emission vehicles such as hybrid electric vehicles (HEV). For HEV drives, in-wheel electric motors which are mounted in the rear wheel axes have many advantages. For instance, the front wheels and rear wheels form a series-parallel drive without special mechanical coupling between them. The wheels of vehicles run in low speed. The dimension of electric machines is inversely proportional to its running speed. If the motor drives the wheel directly, the motor becomes very bulky. As vehicles need to run at low speed, it is inconceivable to use conventional direct motor drives as they are far too bulky and expensive.

Thus, a mechanical gear is needed to reduce the speed. The use of a mechanical gear reduces the motor size, but additional space is needed for the gear. The mechanical gear also reduces the efficiency of energy transmission.

Recently, magnetic gears are proposed to compete with mechanical gears in terms of torque transmission capability and efficiency, as disclosed in “Development of a magnetic planetary gearbox” (Huang et al). Magnetic gears have a highly competitive torque transmission capability with very high efficiency. The magnetic gear can be directly combined with a conventional permanent magnet (PM) motor inside one frame. FIG. 1A shows a PM motor with magnetic gear and FIG. 1B shows a typical flux line distribution of such motor. The motor includes a gear outer rotor 101, iron segments 102, gear inner rotor 103, motor outer rotor 104 and stator 105. The system torque density is significantly improved. However, such system has two rotating parts. Its mechanical structure is complex and it runs noisily due to the multiple rotating parts.

A simple magnetic geared motor that integrates the magnetic gear with a conventional outer-rotor PM brushless motor was presented in L. L. Wang et al., “A novel magnetic-geared outer-rotor permanent-magnet brushless motor.” According to the operating principle of the magnetic gear, it integrates the magnetic gear with a conventional outer-rotor PM brushless motor together. This motor has only one rotary part. The outer-rotor is equipped with sintered neodymium (NdFeB) magnets. FIG. 6 illustrates such a radial-flux-modulated motor (RFMM). The RFMM includes a pole segment 601, outer rotor 602, permanent magnet 603 and stator 604. The stator 604 has a 3-phase concentrated winding which can produce rotary magnetic field with 3 pole pairs, and the outer-rotor is equipped with 22 pole pairs. It has stationary iron segments which are made of silicon steel laminations to modulate the airgap field space harmonics, and the rotor is capable of rotating at low speed. The principle of operation is similar to the magnetic gear. However, the high-speed rotary field is created by an armature rather than with magnets. The overall size of the unit is more compact than a motor and gear combination.

### SUMMARY OF THE INVENTION

According to an aspect of the present invention, the present invention provides an axial-flux electric motor includes a stator having a plurality of stator windings and a plurality of stator pole-pairs, a first rotor configured to magnetically interact with the stator in an axial direction, the first rotor is positioned on one side of the stator, having a plurality of permanent magnets embedded thereon with a plurality of rotor pole-pairs, a second rotor configured to magnetically interact with the stator in the axial direction, the second rotor is position on another side of the stator, having a plurality of permanent magnets embedded thereon with a plurality of rotor pole-pairs, and a plurality of stationary ferromagnetic segments, positioned between the stator and the first rotor and between the stator and the second rotor, the ferromagnetic segments are adapted to modulate magnetic field of the permanent magnets in the axial direction.

Further features and aspects of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1A illustrates a conventional configuration of a conventional magnetic-geared outer-rotor motor.

FIG. 1B illustrates the flux plot on an intersection of the magnetic-geared outer-rotor motor.

FIG. 2 illustrates the components of an axial-modulated-motor in accordance with one embodiment of the present invention.

FIG. 3A illustrates an exemplary stator iron core.

FIG. 3B illustrates an exemplary stator with iron segments.

FIG. 4A illustrates an exemplary stator with iron core and stator windings.

FIG. 4B illustrates an exemplary the iron windings without an iron core.

FIG. 4C illustrates an exemplary a stator winding that is wound back-to-back toroidally.

FIG. 5 illustrates an assembled axial flux electric machine according to one embodiment of the present invention.

FIG. 6 illustrates an exemplary configuration of a radial-flux-modulated PM motor.

FIG. 7 illustrates a plot magnetic flux density on the cross-section of x-z plane of an AFMM.

FIG. 8A illustrates the torque of an AFMM when the rotor is locked.

FIG. 8B illustrates the torque of full-load operation of an AFMM.

FIG. 9A illustrates the induced emf of full-load operation of an AFMM.

FIG. 9B illustrates the coreloss at full-load operation of an AFMM.

FIG. 10 illustrates the cogging torque of an AFMM.

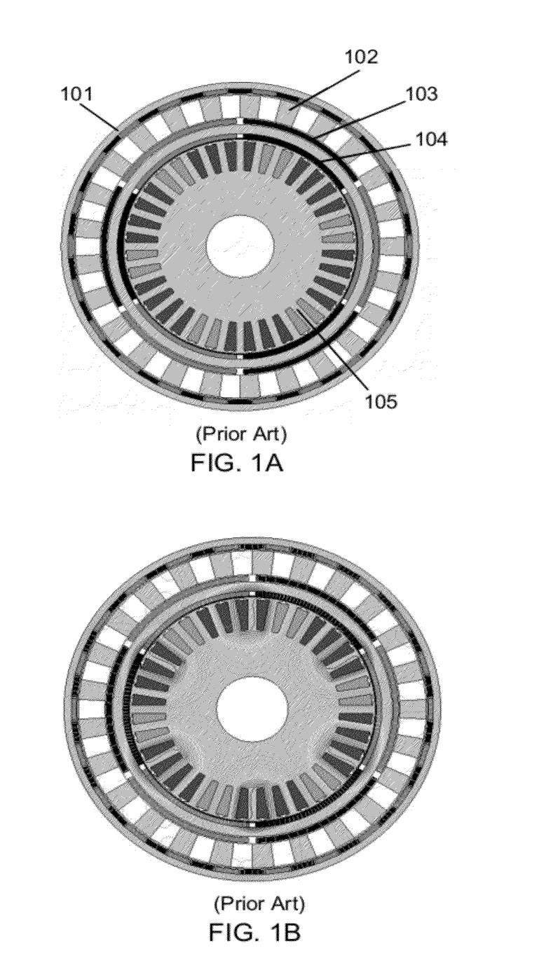

### DESCRIPTION OF THE EMBODIMENTS

The accompanying drawings, which are incorporated in and constitute a part of the specification, illustrate embodiments of the invention and, together with the description, serve to explain the principles of the invention.

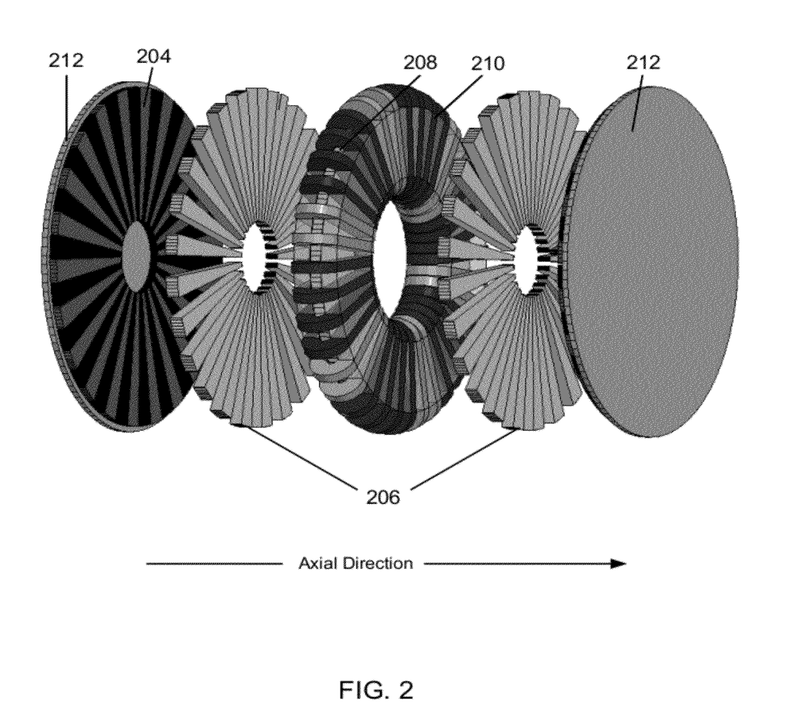

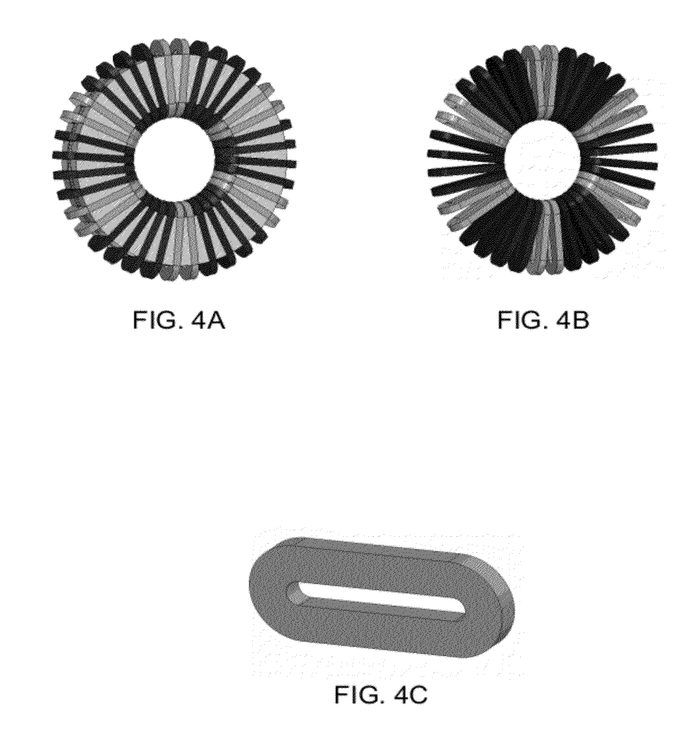

The present invention relates to an axial-flux-modulated motor (AFMM) for the in-wheel gearless drive of motor vehicle such as HEV. Referring to FIG. 2, the AFMM includes 2 outer rotors 212, 2 sets of elongated iron (ferromagnetic) segments 206, and a stationary stator 208 with windings 210. Each element has the same axis of rotation which may be fixed to a shaft (not shown). The outer rotor 212 includes a plurality of permanent magnets 204 embedded thereon, such as NdFeB magnets, having poles facing radially inwards and outwards, that are orientated with alternating polarity (i.e., north and south poles) so that each of the permanent magnet has its poles facing in the opposite direction to the magnets next to it. The rotors are adapted to rotate relative to stator 208. The stator 208 includes a plurality of windings and a stator core that is made of ferromagnetic material. More details of the stator 208 will be explained below in connection with FIGS. 4A-4C.

In one embodiment, the AFMM has a 3-phase concentrated winding which can produce a rotary magnetic field with 3 pole pairs in an axial direction, and each of the outer-rotor has 22 pole pairs. Iron segments 206 in the airgap can be used to modulate the magnetic fields of the permanent magnets so that the outer rotors rotate relative to the stator in a geared manner. The iron segments, which are not limited to any particular shapes, are fixed on the stator.

The motor can operate with high power density at low speed, and hence, can be used as direct drives in electric vehicles. Its manufacturing and assembling process are simple when compared with those of radial-flux-modulated motor (RFMM). With AFMM, the front wheels and rear wheels can operate as a series-parallel drive without special mechanical coupling between them.

Due to the space constraints in a wheel of a motor vehicle, the disc shape and dimension should be well suited for direct coupling of the motor the wheel. The present AFMM is suitable to be fitted into a wheel of an electric vehicle. In addition, since the ratio between the airgap diameter and the axial length of iron cores is large, the axial-flux design can significantly boost the torque density.

The manufacture process of AFMM is much simpler than that of the radial-flux-modulated motor (RFMM). Both the iron segments 206 and the stator 208 are made from soft magnetic compound (SMC) materials in modular structures and can be assembled easily.

The coils 210 on the two sides of the stator core are wound back-to-back toroidally to shorten the length of the end windings sharing a common back iron, thereby saving the copper material and improving the power density. In addition, because of the small number of stator slots, the slot space is used efficiently. The motor provides good heat dissipation because of the naturally formed ventilating ducts (airgap) between the iron segments and the outer rotors.

In flux-modulated motors (FMM), the numbers of pole pairs of the stator and the rotor are different. Usually the rotor permanent magnets have large number of pole pairs as it rotates at low speed. The stator has armature windings and it has small number of pole pairs so that the number of slots can be small. As illustrated in FIG. 2, stationary iron segments are placed between the stator and the rotor. These iron segments are capable of modulating magnetic field produced by the stator windings so that the number of pole pairs of one high-order harmonics is the same as that of the PM rotor. Therefore positive average output torque can be produced by the reactions between the magnetic fields of the stator and the rotor. According to the theory of magnetic gears, as discussed in Huang et al., “Development of a magnetic planetary gearbox,” the gear ratio of the stationary iron pieces is:

$${G}_{r} = \frac{{p}_{stator} - {N}_{iron}}{{p}_{stator}} \qquad ( 1 )$$

where pₛₜₐₜₒᵣ represents the number of stator pole pairs, Nᵢᵣₒₙ represents the number of stationary iron segments. The number of rotor pole pairs pᵣₒₜₒᵣ should be |Gᵣ|pₛₜₐₜₒᵣ. Therefore, the relationship among the number of stator pole pairs pₛₜₐₜₒᵣ, the number of rotor pole pairs pᵣₒₜₒᵣ and the number of stationary iron pieces Nᵢᵣₒₙ is:

Nᵢᵣₒₙ−pₛₜₐₜₒᵣ=pᵣₒₜₒᵣ (2)

In this manner, gear ratio can be adjusted by simply modifying pᵣₒₜₒᵣ, pₛₜₐₜₒᵣ or Nᵢᵣₒₙ.

The performance of a AFMM is compared with a RFMM. In both motors, the number of pole pairs in the stator pₛₜₐₜₒᵣ is 3 but the number of pole pairs in the rotor pᵣₒₜₒᵣ is 22. The number of stationary iron pieces Nᵢᵣₒₙ is 25. The gear ratio

$${G}_{r} = \frac{3 - 25}{3} = - \frac{22}{3} and \vert {G}_{r} \vert {p}_{stator} = \frac{22}{3} \times 3 = 22 = {p}_{rotor} .$$

To compare the power densities, the RFMM and the AFMM have the same installation dimensions.

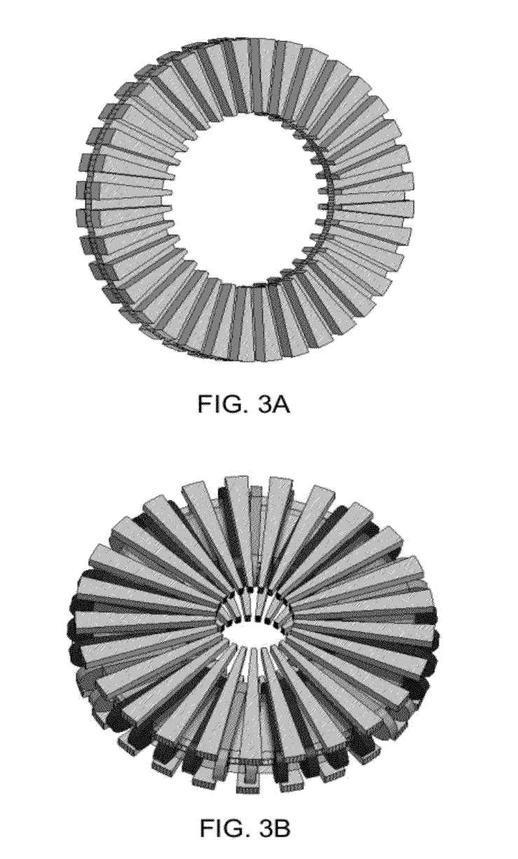

FIGS. 3A and 3B illustrate the stator iron core and stator iron core with windings and iron segments, respectively. The stator iron core includes a number of stator slots for the windings. FIG. 4A illustrates a stator with stator iron core in its middle. For illustrative purposes, an exemplary stator winding are shown in FIG. 4B. The coils on the two sides of the stator core are wound back-to-back toroidally (FIG. 4C). The design data is listed in Table I in accordance with one embodiment of the present invention.

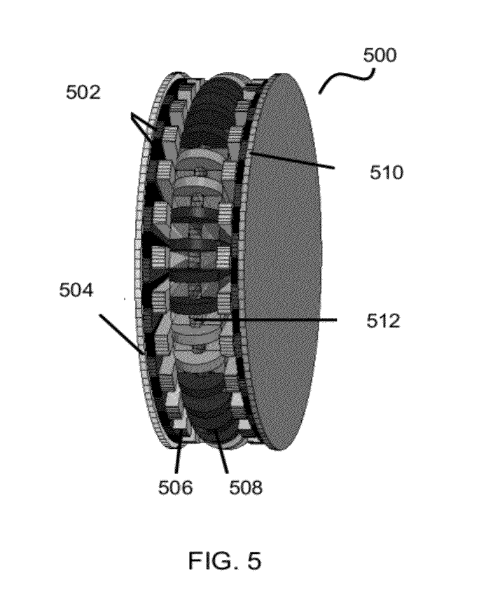

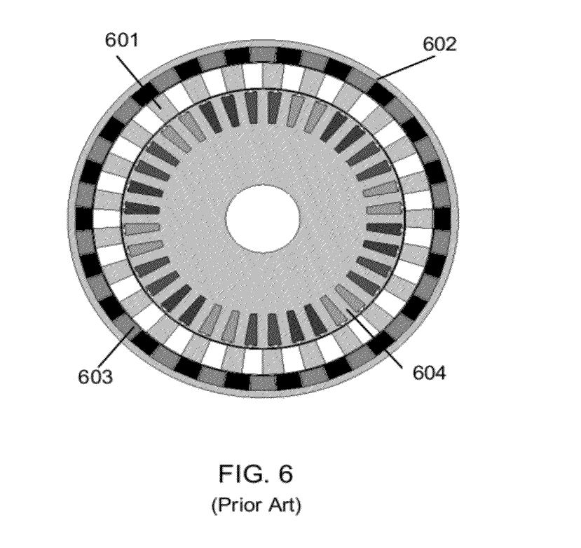

FIG. 5 illustrates an assembled view of an axial flux electric machine 500 according to one embodiment of the present invention. It includes outer rotors (504 and 510) having permanent magnets embedded thereon, stator 512 with windings 508, and iron segments 506.

To compare the performance with RFMM, the values of INₛₗₒₜN_{conductor} for the AFMM and RFMM are the same (see Table II), where I is the phase current, Nₛₗₒₜ is the number of stator slots and N_{conductor} is the number of conductors in each slot. Both machines have the same axial lengths, the same outside frame radii, the same phase numbers, the same stator pole number and rotor pole number, the same total thicknesses of PM and the same copper losses. There are 3 phases in both AFMM and RFMM. The supply frequency is 220 Hz. The rotor runs at 600 rpm.

TABLE I
DESIGN DATA OF AXIAL FLUX-
MODULATED MOTOR (AFMM)

| | | |
|---|---|---|
| Frequency | 220 | Hz |
| Total axial length | 64 | mm |
| Outside radius | 92 | mm |
| Inside radius | 60 | mm |
| Thickness of PM | 3.9 | mm |
| Thickness of stationary iron | 6.5 | mm |
| Airgap between PM and stationary iron | 0.6 | mm |
| radius of stationary ring | | |
| Airgap between stationary iron and stator | 0.6 | mm |

| | |
|---|---|
| Number of outer rotor pole pairs | 22 |
| Number of stationary iron segments | 25 |
| Number of stator pole pairs | 3 |
| Number of stator slots | 36 |

TABLE II
ELECTRIC LOADINGS OF TWO DIFFERENT MOTORS

| Motor type | RFMM | AFMM |
|---|---|---|
| Nₛₗₒₜ | 36 | 36 |
| N_{conductor} | 5 | 5 |
| I (A) | 159.77 | 124.4 |

The base of comparison on the power density of different motors is that the temperature rises at full-load are the same for the two motors. For simplicity, the total losses in the motors are assumed to be the same. Because the coreloss is only a small percentage of the total losses in these motors, it is assumed that the copper losses are the same.

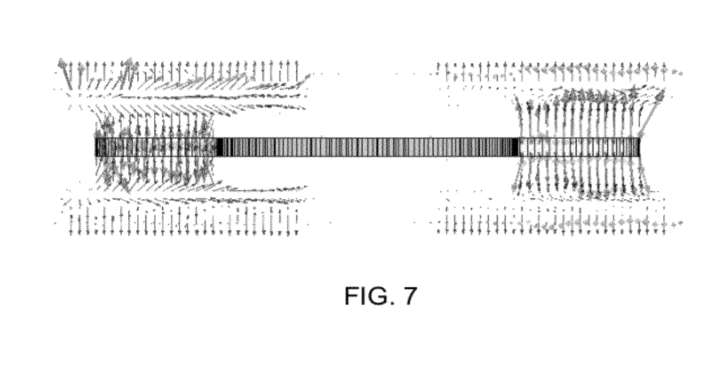

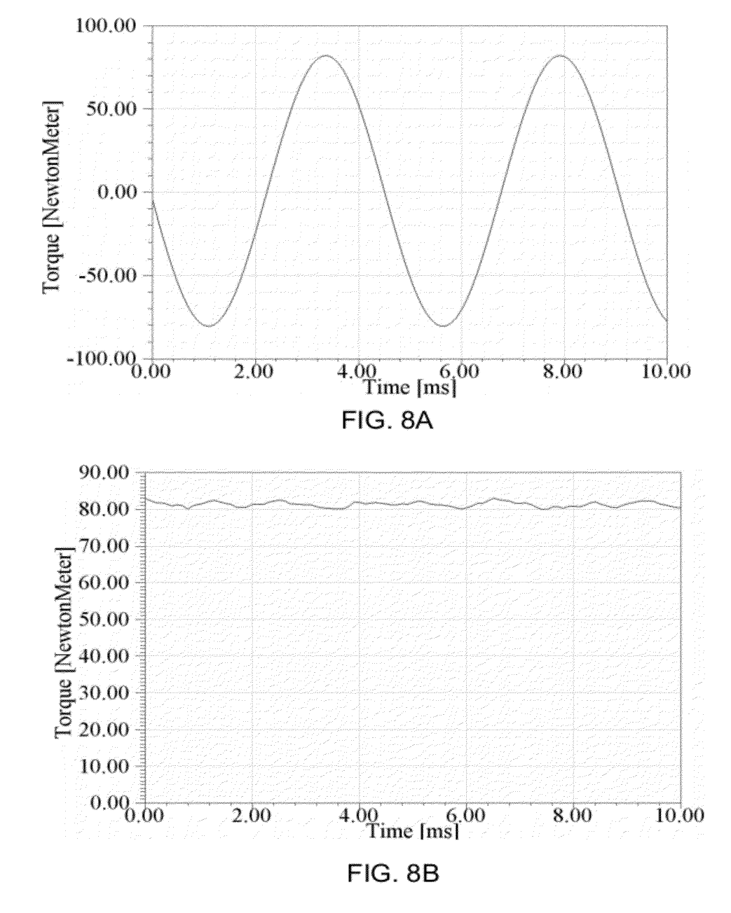

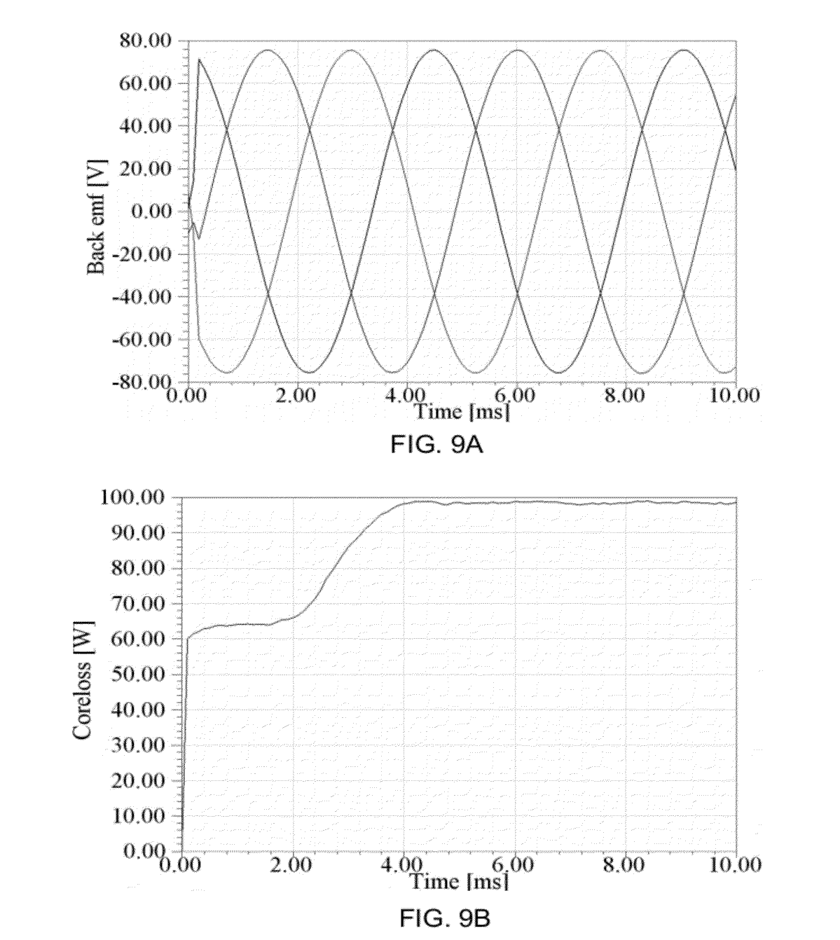

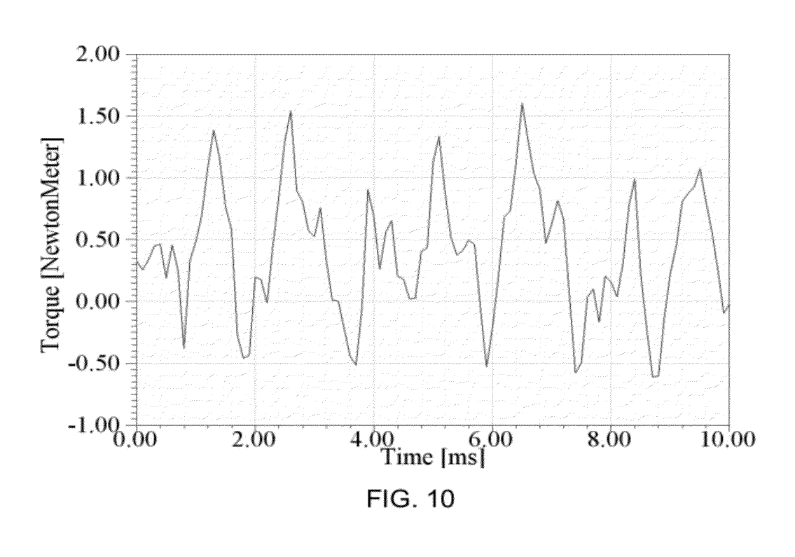

The performances of AFMM are analyzed by using 3-D time-stepping finite element method of transient magnetic field-electric circuit-mechanical motion coupled model. The plot of magnetic flux density on the cross-section of x-z plane (z is the axial direction of the motor) is shown in FIG. 7. When the rotor is locked, the torque curve is shown in FIG. 8A. The torque curve and back emf curves versus time at full-load are shown in FIGS. 8B and 9A, respectively. The coreloss curve versus time at full-load is shown in FIG. 9B. The cogging torque, which is the torque due to the interaction between the permanent magnets of the rotor and the stator slots, is shown in FIG. 10.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

What is claimed is:

1. An axial-flux electric motor, comprising:
a stator having a plurality of stator windings and a plurality of stator pole-pairs;
a first rotor configured to magnetically interact with the stator in an axial direction, the first rotor is positioned on one side of the stator, having a plurality of permanent magnets embedded thereon with a plurality of rotor pole-pairs;
a second rotor configured to magnetically interact with the stator in the axial direction, the second rotor is position on another side of the stator, having a plurality of permanent magnets embedded thereon with a plurality of rotor pole-pairs; and
a plurality of stationary ferromagnetic segments, positioned between the stator and the first rotor and between the stator and the second rotor, the ferromagnetic segments are adapted to modulate magnetic field of the permanent magnets in the axial direction.

2. The axial-flux electric motor of claim 1, wherein the stator includes a core that is made of ferromagnetic material.

3. The axial-flux electric motor of claim 1, wherein number of the stator pole pairs (Pₛₜₐₜₒᵣ) and number of the rotor pole pairs (Pᵣₒₜₒᵣ), and number of the ferromagnetic segments (Nᵢᵣₒₙ) are related as Nᵢᵣₒₙ−pₛₜₐₜₒᵣ=pᵣₒₜₒᵣ.

4. The axial-flux electric motor of claim 3, wherein Pᵣₒₜₒᵣ of the first rotor are the same as Pᵣₒₜₒᵣ of the second rotor.

5. The axial-flux electric motor of claim 1, wherein the stator windings are wound back-to-back toroidally.

6. The axial-flux electric motor of claim 1, wherein the stator windings are armature windings.

7. The axial-flux electric motor of claim 1, wherein the permanent magnets are NdFeB magnets.

8. The axial-flux electric motor of claim 1, wherein the stator and the ferromagnetic segments are made from soft magnetic compound.

9. The axial-flux electric motor of claim 1, wherein airgaps, between the stator and the first and second rotors, are adapted to provide heat ventilation.

10. The axial-flux electric motor of claim 1, wherein the stator, the first and second rotors, and the ferromagnetic segments are configured to be fitted in a wheel of a motor vehicle.
